(19) United States
(12) Patent Application Publication
(10) Pub. No.: US 2003/0039871 A1
(43) Pub. Date: Feb. 27, 2003

(54) Method of controlling a fuel cell system

(75) Inventors: Andreas Christen, Allendorf (DE); Steffen Wieland, Heilbronn (DE)

Correspondence Address: THE FIRM OF KARL F ROSS, 5676 RIVERDALE AVENUE, PO BOX 900, RIVERDALE (BRONX), NY, 10471-0900, US

(73) Assignee: BUDERUS HEIZTECHNIK GmbH

(21) Appl. No.: 09/940,254

(22) Filed: Aug. 27, 2001

(51) Int. Cl. H01M 8/04; H01M 8/06

(52) U.S. Cl. 429/17; 429/24

(57) ABSTRACT

A reformer supply synthesis gas to a fuel cell and startup and shutdown of the system are controlled so that air is supplied initially to the catalyst body to flush the latter before heating builds up the temperature to support the production of the synthetic gas. The shutdown is effected with air flow after the fuel supply is interrupted to burn off soot deposits and dry the catalyst body.

### FIELD OF THE INVENTION

The present invention relates to a method of controlling a fuel cell system and, more particularly, to a method of controlling a fuel cell system which is supplied with a fuel gas, usually synthesis gas, from a reformer to which a fuel (usually a hydrocarbon), air and water can be fed.

### BACKGROUND OF THE INVENTION

Fuel cells convert hydrogen or hydrocarbon containing fuels directly into electric current. The heat generated in the fuel cell can also be utilized for heating purposes.

In some instances the fuel for the fuel cell is a hydrogen-rich synthesis gas which can be generated from a hydrocarbon, e.g. methane. The methane is supplied together with air and water to a reformer which may contain a body of a catalyst capable of reforming the methane to a gas mixture rich in hydrogen and referred to here as the synthesis gas.

In German Patent Document DE 19 947 880 A1, the temperature in the reformer is controlled by feeding inert water thereto. In the European Patent Document EP 0 973 220 A2, the temperature is controlled by the metered addition of air and water to the reformer. The oxidation reaction in the reformer is exothermic and drives the endothermic reformation of the water vapor to hydrogen. The control parameter is usually the temperature. In German Patent Document DE 197 07 814 C1, the hydrogen-rich reformate is introduced into a fuel cell as a function of its quality. The control of the temperature of the reformer during operation is described in the European Patent Publications EP 0 978 476 A1 and EP 0 973 219 A2.

During the start up and shut down processes, however, gases are produced in the reformer which can be detrimental or poisonous to the fuel cell. In addition, soot can be produced in the reforming process and can lodge in the pores of the catalyst and can be detrimental to the reaction which is desired.

When the catalyst or the gases traversing same are cooled below the dewpoint, it is possible for moisture to be deposited in the pores of the catalyst as well so that reheating can be required and the result can eventually be a mechanical breakdown of the catalyst body.

### OBJECTS OF THE INVENTION

It is therefore, the principal object of the present invention is to provide an improved method of controlling the operation of a fuel cell system or of operating a fuel cell system utilizing a reformer whereby the aforementioned drawbacks are avoided.

Another object of this invention is to provide a method of operating a fuel cell system utilizing a reformer upstream of the fuel cell, whereby damage to the catalyst body of the reformer and/or the fuel cell is minimized and the life of the system is increased.

### SUMMARY OF THE INVENTION

These objects and others which will become apparent hereinafter are attained, in accordance with the invention, in a method of controlling a fuel cell system wherein a reformer produces a hydrogen-rich synthesis gas from a hydrogen-rich fuel with addition of air and water by partial oxidation or autothermic reforming, and the hydrogen-rich synthesis gas and an oxygen-containing gas (e.g. air) are fed to a fuel cell to generate electrical energy, the method comprising the steps of:

(a) for start up and shut down of the reformer, flushing the reformer with air whereby a synthesis or waste gas is produced in the reformer during the flushing thereof; and

(b) bypassing at least part of the synthesis or waste gas produced in the reformer during the flushing thereof past the fuel cell.

During startup of the reformer, after flushing of the reformer with air, a combustion process is effected in the reformer with substantially complete combustion of the fuel with air fed to the reformer, and only upon reaching an optimal reaction temperature in the reformer are the hydrogen-rich fuel, air and water supplied to the reformer in such quantities and proportions as to effect and control the partial oxidation or autothermic reforming for producing the hydrogen-rich synthesis gas and operating the fuel cell therewith.

The optimal reaction temperature referred to above is reached in the reformer when the temperature in the reformer is sufficient to vaporize water introduced into the reformer.

At least part of the synthesis or waste gas produced during the flushing thereof and bypassing the fuel cell can be reacted in an afterburner, preferably a catalytic afterburner. According to a feature of the invention, during shut down of the reformer, supply of the fuel to the reformer is first terminated and air and water continue to be supplied to the reformer.

In addition or alternatively, during shut down of the reformer the supply of air and water thereto is reduced as required by reaction conditions therein.

In still another alternative or, in addition, during shut down of the reformer, soot deposits in a catalyst region of the reformer are burned off by controlled introduction of air into the reformer and in the presence of water vapor as a moderator.

Feed of water to the reformer can be interrupted as soon as a temperature in the reformer remains constant or falls, with dry air then being flushed through the reformer.

As a consequence, during the starting up process, reaction residues and moisture in the reformer are initially removed by flushing with air and then a complete combustion process is carried out to raise the temperature in the reformer. The resulting hot gas can be utilized to heat the reformer as well as systems downstream of the reformer other than the fuel cell which is bypassed. These systems may include the gas treatment stages downstream of the fuel cell and the reformer, systems for preheating the gases utilized in the reformer, a waste heat boiler or the like. Maximum utilization of the waste gas bypassing the fuel cell can be achieved by the use of the afterburner and preferably by the use of the catalytic afterburner. Only when the optimum reaction temperature for the reforming reaction is reached are the air, fuel and/or water quantities admitted to the afterburner controlled and proportioned so that the partial oxidation and autothermic reformation can be carried out for maximum hydrogen production. The optimum reaction temperature is reached when the reactor has a known predetermined conversion of fuel to hydrogen with the desired throughput for operating the fuel cell. During the use of the afterburner or the bypass, it has been found to be advantageous to permit a portion of the gases from the reformer to pass through the fuel cell so as to maintain the reaction therein while limiting the introduction of contaminating or poisoning substances.

The shut down of the reformer is carried out with interruption in the fuel supply and then reduction of the air and water influx as a function of the reaction conditions and such as to allow possible soot deposits to be burned off. In the latter case water vapor is used as a moderator and the H₂0 input can be terminated when the temperature in the reformer remains constant or drops. To dry the catalyst body in the reformer, air can continue to flow, usually at a reduced rate therethrough. The control method of the invention is simple and can eliminate costly techniques which have been found to be necessary heretofore. Monitoring of the process can be effected utilizing simply measured parameters, for example, temperatures, and the reformer can be free from mechanical stresses and problems resulting from deposit and moisture accumulations. The reformer can thus have a greater robustness than has hitherto been the case.

### BRIEF DESCRIPTION OF THE DRAWING

The above and other objects, features, and advantages will become more readily apparent from the following description, reference being made to the accompanying drawing in which:

FIG. 1 is a graph illustrating the operation of a fuel cell system according to the invention; and

FIG. 2 is a flow diagram illustrating the principals of the invention.

### SPECIFIC DESCRIPTION

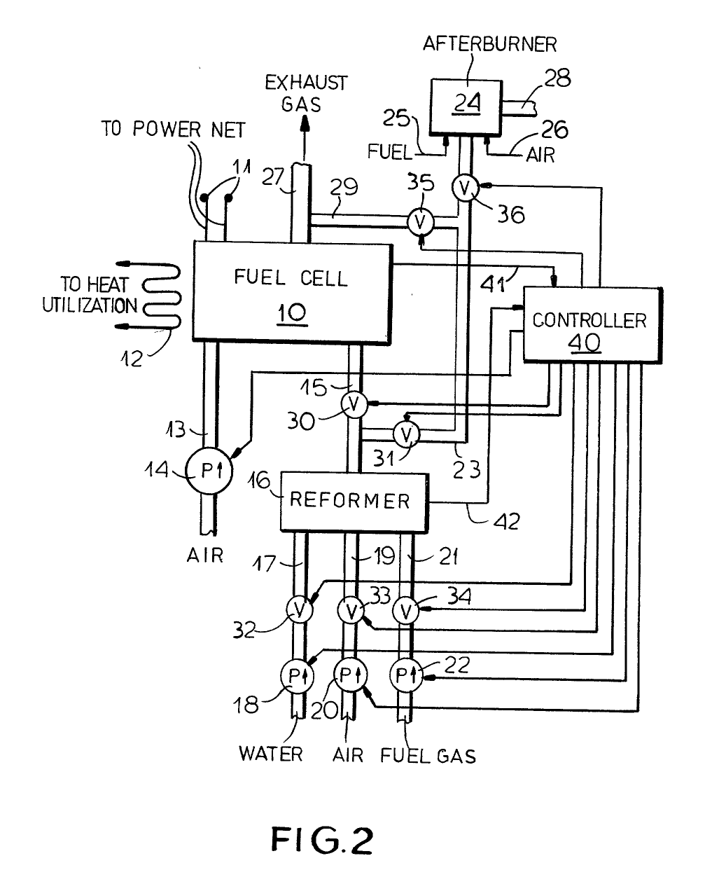

Referring first to FIG. 2, it can be seen that a fuel cell 10 which can supply an electric network at 11 and can generate heat for utilization elsewhere as represented at 12, can be supplied with air via a line 13 and a compressor 14. The “fuel” supplied to the fuel cell is delivered by a line 15 and is in the form of synthesis gas from a catalytic reformer 16 which is supplied with water via line 17 and pump 18, with air via line 19 and compressor 20 and with a hydrogen-rich gaseous fuel, usually a hydrocarbon such as methane, via line 21 and the pump 22.

According to the invention, a bypass 23 is provided at the outlet of the reformer 16 and can permit bypassed gas to be utilized for other heating purposes, e.g. via a catalytic afterburner 24 to which fuel can be supplied at 25 and air at 26. The exhaust gas from the fuel cell is discharged at 27 and can be supplied to a gas cleaning installation and the gas discharged at 28 from the afterburner can be used to preheat the fluid supplied to the afterburner or to heat the gas cleaning system as may be desired.

A pipe 29 has been shown to permit a portion of the discharged gas from the bypass to flow to the line 27. The amount of gas which is bypassed from the reformer is controlled by valves 30 and 31 and further valves 32, 33 and 34 can control the fluids fed to the reformer 16. Valves 35 and 36 are also provided on the bypass line.

The valves 30 to 36, the pumps 18, 20 and 22 and the compressor 14 are operated by a controller 40, e.g. a microprocessor system provided with firmware to effect the programmed operation described below and receiving inputs at 41 and 42, for example, representing the temperatures in the fuel cell and the reformer respectively.

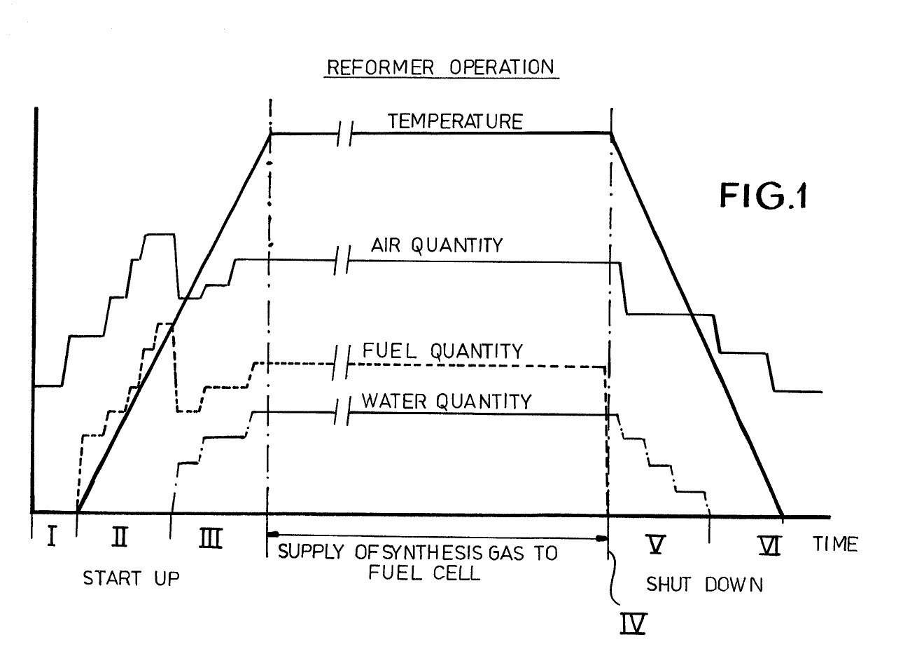

The graph of FIG. 1 represents the operation of the reformer and particularly the start up and shut down phases thereof and the steady state operation between these phases. During the steady state operation the temperature remains constant, the air quantities, fuel quantities and water, likewise are generally constant and are at the respective proportions to provide the optimum output of synthesis gas. While all of these values are shown to be strictly constant in the graph, they, of course, can vary, in which case the proportions should remain the same. During the start up phase, initially the reformer is flushed with air (phase I). That is followed by a combustion phase in which the fuel is burned with air in a complete combustion reaction on the catalyst until the reaction temperature rises to that which is sufficient to maintain the partial oxidation reformation reaction (phase II). At that point water can be supplied and is evaporated with the heat generated in the catalyst body. The air quantity is then reduced until the hydrogen is generated at the desired rate (phase III). The control of the air and fuel quantities during this start up phase is continued until all of the reaction partners for the partial oxidation or reformation reaction are present and during this startup (phases I-III), the gases produced in the reformer are primarily bypassed around the fuel cell and burned off in the afterburner 24. The gases can deliver heat through heat exchangers for whatever other purposes may be required in the system.

During the shut down phase, the fuel quantity is cut off at the point IV although both water and air continue to flow over the interval V, burning up any soot deposits with the water vapor being present as a moderator. The thermal inertia of the system provides enough heat for vaporization of the water for this purpose. The water quantity is progressively reduced and interrupted when the temperature falls say to just above the dewpoint.

Air continues to be supplied (phase VI) until the temperature drops fully, thereby insuring drying of the catalyst body or removal of moisture therefrom.

We claim:

1. A method of controlling a fuel cell system wherein a reformer produces a hydrogen-rich synthesis gas from a hydrogen-rich fuel with addition of air and water by partial oxidation or autothermic reforming, and the hydrogen-rich synthesis gas and an oxygen-containing gas are fed to a fuel cell to generate electrical energy, said method comprising the steps of:
(a) for start up and shut down of the reformer, flushing said reformer with air whereby a synthesis or waste gas is produced in the reformer during the flushing thereof; and
(b) bypassing at least part of the synthesis or waste gas produced in the reformer during the flushing thereof past said fuel cell.

2. The method defined in claim 1 wherein during start up of said reformer, after flushing of the reformer with air, a combustion process is effected in said reformer with substantially complete combustion of said fuel with air fed to the reformer, and only upon reaching an optimal reaction temperature in said reformer are said hydrogen-rich fuel, air and water supplied to said reformer in such quantities and proportions as to effect and control the partial oxidation or autothermic reforming for producing the hydrogen-rich synthesis gas and operating said fuel cell therewith.

3. The method defined in claim 2 wherein said optimal reaction temperature is reached in said reformer when the temperature in said reformer is sufficient to vaporize water introduced into said reformer.

4. The method defined in claim 3 wherein at least part of the synthesis or waste gas produced in the reformer during the flushing thereof and bypassing said fuel cell is reacted in an afterburner.

5. The method defined in claim 4 wherein the afterburner is operated as a catalytic burner.

6. The method defined in claim 5 wherein during shut down of said reformer, supply of said fuel to said reformer is first terminated and air and water continue to be supplied to said reformer.

7. The method defined in claim 6 wherein during shut down of said reformer the supply of air and water thereto is reduced as required by reaction conditions therein.

8. The method defined in claim 7 wherein, during shut down of said reformer, soot deposits in a catalyst region of the reformer are burned off by controlled introduction of air into said reformer and in the presence of water vapor as a moderator.

9. The method defined in claim 8 wherein, during shut down of said reformer, feed of water to the reformer is interrupted as soon as a temperature in said reformer remains constant or falls, and then drying air is flushed through the reformer.

10. The method defined in claim 1 wherein at least part of the synthesis or waste gas produced in the reformer during the flushing thereof and bypassing said fuel cell is reacted in an afterburner.

11. The method defined in claim 1 wherein the afterburner is operated as a catalytic burner.

12. The method defined in claim 1 wherein during shut down of said reformer, supply of said fuel to said reformer is first terminated and air and water continue to be supplied to said reformer.

13. The method defined in claim 1 wherein during shut down of said reformer the supply of air and water thereto is reduced as required by reaction conditions therein.

14. The method defined in claim 1 wherein, during shut down of said reformer, soot deposits in a catalyst region of the reformer are burned off by controlled introduction of air into said reformer and in the presence of water vapor as a moderator.

15. The method defined in claim 8 wherein, during shut down of said reformer, feed of water to the reformer is interrupted as soon as a temperature in said reformer remains constant or falls, and then drying air is flushed through the reformer.

16. A method of operating a fuel cell system comprising the steps of:
(a) producing a hydrogen-rich synthesis gas from a hydrogen-rich fuel with addition of air and water in a catalytic reformer by partial oxidation or autothermic reforming;
(b) feeding the hydrogen-rich synthesis gas and an oxygen-containing gas are fed to a fuel cell to generate electrical energy;
(c) for start up and shut down of the reformer, flushing said reformer with air whereby a synthesis or waste gas is produced in the reformer during the flushing thereof; and
(d) bypassing at least part of the synthesis or waste gas produced in the reformer during the flushing thereof past said fuel cell and reacting at least a portion of the bypassed part in a catalytic afterburner.

17. The method defined in claim 16 wherein during start up of said reformer, after flushing of the reformer with air, a combustion process is effected in said reformer with substantially complete combustion of said fuel with air fed to the reformer, and only upon reaching an optimal reaction temperature in said reformer are said hydrogen-rich fuel, air and water supplied to said reformer in such quantities and proportions as to effect and control the partial oxidation or autothermic reforming for producing the hydrogen-rich synthesis gas and operating said fuel cell therewith.

18. The method defined in claim 17 wherein said optimal reaction temperature is reached in said reformer when the temperature in said reformer is sufficient to vaporize water introduced into said reformer.

19. The method defined in claim 18 during shut down of said reformer supply of said fuel to said reformer is first terminated and air and water continue to be supplied to said reformer, the supply of air and water thereto being reduced as required by reaction conditions therein, soot deposits in a catalyst region of the reformer are burned off by controlled introduction of air into said reformer and in the presence of water vapor as a moderator, the feed of water to the reformer being interrupted as soon as a temperature in said reformer remains constant or falls, drying air being then flushed through the reformer.
